(19) United States
(12) Patent Application Publication
(10) Pub. No.: US 2007/0078680 A1
(43) Pub. Date: Apr. 5, 2007

(54) Systems and methods for analysis of healthcare provider performance

(76) Inventor: David E. Wennberg, Cape Elizabeth, ME (US)

Correspondence Address: FISH & NEAVE IP GROUP;ROPES & GRAY LLP, ONE INTERNATIONAL PLACE, BOSTON, MA, 02110-2624, US

(21) Appl. No.: 11/542,574

(22) Filed: Oct. 3, 2006

Related U.S. Application Data
(60) Provisional application No. 60/723,257, filed on Oct. 3, 2005.

(51) Int. Cl. G06Q 10/00; G06G 7/48

(52) U.S. Cl. 705/2; 703/6

(57) ABSTRACT

A system for measuring unwarranted healthcare service variations including the process of accessing patient data associated with a patient population, applying a predictive model to the patient data to determine the number of times that a healthcare measure is expected to occur, accessing the patient data to determine the number of times that the healthcare measure occurred, and comparing the number of times that the measure occurred with the number of time that the measure was expected to occur to identify the unwarranted healthcare service variation.

### REFERENCE TO RELATED APPLICATIONS

This application claims the benefit of and priority to U.S. Provisional Application No. 60/723,257, filed on Oct. 3, 2005, entitled “Methods and Systems For Analysis of Healthcare Provider Performance.” This application is with U.S. patent application Ser. No. 11/280,611 and U.S. patent application Ser. No. 11/281,233, both filed on Nov. 16, 2005. The entire contents and teachings of the above referenced applications are incorporated herein by reference.

### FIELD OF THE INVENTION

The invention relates generally to methods and systems for healthcare system analysis. More particularly, in various embodiments, the invention relates to applying predictive modeling to healthcare information to analyze the performance of healthcare providers.

### BACKGROUND

Consumers and purchasers of healthcare services, whether individuals or employers, are demanding increasingly superior healthcare services at a decreasing cost. The need for some measure of economic effectiveness and efficiency of health care providers is becoming more acute with the introduction of consumer-driven health plans by employers. Thus, healthcare providers are under great market pressure to improve or maintain their healthcare services to clients, while focusing on the profitability of their business. Profitability and customer satisfaction are inextricably linked to the efficiency by which healthcare providers provide healthcare, manage their resources, and manage the risks, both financial and medical, that are inherent to the healthcare business.

Healthcare consumers are faced with difficult circumstances. Costs have been rising at high rates, while confidence in the quality of services has been decreasing. However, there is not yet an adequate solution to address these problems. Existing managed care systems seemed, at first, to be a healthcare system altering solution with the implementation of strategies such as utilization management, provider price negotiations and restricted provider panels. Yet managed care still does not address one of healthcare's principle cost and quality drivers; unwarranted variations in medical practice.

In the “post managed care environment,” consumer-directed health plans have gained momentum, along with high deductibles for employees and their families. As a result, consumers of healthcare now require a more transparent view of the true costs and quality of their medical care, a view that can be provided by the unwarranted variation lens.

Health plans' and employers' most recent response to these cost and quality issues has increasingly been to look to provider measurement systems aimed at guiding the selection of providers who consistently deliver “high quality, cost effective care” to their members and employees. However, profiling systems developed in the past ten years have focused primarily on measuring utilization and cost of services.

In response to the poor acceptance by the provider community, attempts have been made over time to control healthcare costs for patient mix and severity of illness. Most recently, profiling systems have relied on grouping patients' care needs into episodic care clusters to measure a provider's efficiency at meeting patients' health needs while ignoring the providers' choice of treatment of the patient or an entire population of patients over time. These systems tend to favor the providers who can provide care efficiently within episodes of care, while allowing over-utilization across a large number of episodes to remain undetected.

Accordingly, there remains a widespread need for improved mechanisms to assist healthcare providers and employers to lower healthcare costs while providing superior quality of healthcare to patients. For other healthcare providers such as health insurers and managed care organizations (“MCOs”), there also exists a need for determining which healthcare providers provide the most or least efficient care, which can enable the development of incentive strategies to promote cost-efficient, high quality, and consistent healthcare services throughout the healthcare system.

### SUMMARY OF THE INVENTION

The invention, in various embodiments, is directed to systems, methods, and/or devices relating to determining the longitudinal efficiency and cost-effectiveness of services provided by healthcare providers. According to one feature, the invention identifies one or more measures or treatments that are expected for each patient of a population of patients based, in part, on a selected set of predictors for each expected measure. A predictor may include a medical procedure, risk event, diagnosis, and/or treatment. A predictor may also include clinical predictors such as comorbidities and contraindications.

A predictive model is employed to determine whether, based on the patent data and/or predictors associated with a particular patient, a particular measure was expected. The predictive model may include a statistical model, retrospective model, or a rules-based model. The statistical model may include a decision tree, Bayesian network, Markov, logistic regression, Poisson, or other like model. The rules-based model may include a Boolean or decision tree based model. The rules-based model may include predictors that are agreed upon by a panel of experts using a collective agreement process such as a modified Delphi technique. The predictive model may be applied to each member of a population or group of patients. A portion of patients of the population is then identified that is expected to have received the expected healthcare measure.

In one feature, the number of expected occurrences of a measure is compared with the number of actually observed occurrences of that measure within a particular patient population. For example, if the patient population is associated with a particular hospital, then the variation of expected measures with the actually observed measures can be determined for that hospital. The difference between the number of observed and the expected measures may be considered an unwarranted variation of healthcare service. This unwarranted variation of healthcare service may be compared with the estimated unwarranted variations of other hospitals to identify various portions or ranges of hospitals with different degrees of unwarranted variation. Unwarranted variation may be defined as differences in healthcare service delivery that are not driven and/or cannot be explained by illness or medical need and the dictates of evidence-based medicine. Incentive strategies or other procedures may be implemented to encourage those hospitals or other groups to reduce the amount of unwarranted variation associated with a particular measure, e.g., treatment or procedure.

The patient data may include information such as medical claims data, pharmacy claims data, referral post hospital discharge data, health risk assessment and functional status data, laboratories values, pre-notification or authorization data, and other risk factor data.

In various embodiments, the invention provides, without limitation, mathematical models, algorithms, methods, systems, devices, computer program codes, and computer readable mediums for performing the above predictive models to identify expected healthcare measures and measure longitudinal healthcare efficiencies.

In one aspect, the invention employs a software application running on a computer system for measuring longitudinal healthcare efficiencies. The software application may perform functions including: accessing patient data associated with a patient population, applying a predictive model to the patient data to determine the number of times that a healthcare measure is expected to occur, accessing the patient data to determine the number of times that the healthcare measure occurred, and comparing the number of times that the measure occurred with the number of time that the measure was expected to occur to identify the unwarranted healthcare service variation.

In one feature, the invention performs the above steps for a plurality of different patient populations. Then, the invention compares the unwarranted healthcare service variations of the plurality of patient populations to identify populations associated with one or more ranges of unwarranted healthcare service variation. In another feature, the patient population is associated with one of a physician, a physician practice, a hospital, a state, and a region.

In one configuration, the invention measures the unwarranted healthcare service variation as a difference in the number of times that the measure occurred with the number of time that the measure was expected to occur. In another configuration, the invention measures the unwarranted healthcare service variation as a ratio of the number of times that the measure occurred to the number of time that the measure was expected to occur. The healthcare measure may be categorized into one or more categories. The categories may include at least one of effective care, supply sensitive care, and preference sensitive care.

In another configuration, the predictive model includes at least one of a rules-based model and a statistical model. The rules-based model may include a decision process of a panel of experts that identify one or more predictors associated with a measure. The panel may use at least portions of a Delphi technique to agree upon one or more predictors. The predictive model may include at least one of a logistic regression or other statistical model that identifies one or more predictors that are associated with a measure.

The invention will now be described with reference to various illustrative embodiments.

### BRIEF DESCRIPTION OF THE DRAWINGS

The foregoing and other objects, features, advantages, and illustrative embodiments of the invention will now be described with reference to the following drawings in which like reference designations refer to the same parts throughout the different views. These drawings are not necessarily to scale, emphasis instead being placed upon illustrating principles of the invention.

FIG. 1 is a conceptual block diagram of a healthcare expected measure predictive modeling analytic system according to an illustrative embodiment of the invention.

FIG. 2 is a functional block diagram of a computer for performing a predictive analysis according to an illustrative embodiment of the invention.

FIG. 3 is a conceptual representation of the combination of effective care, supply sensitive care, and preference sensitive care associated with determining unwarranted variation of healthcare service according to an illustrative embodiment of the invention.

FIG. 4 is an exemplary graphical chart showing the distribution of variations in effective care for healthcare providers at various ranges of observed/expected ratios according to an illustrative embodiment of the invention.

FIG. 5 is an exemplary graphical chart showing the distribution of variations in supply sensitive care for healthcare providers at various ranges of observed/expected ratios according to an illustrative embodiment of the invention.

FIG. 6 is a flow diagram of an exemplary healthcare system expected measure predictive process according to an illustrative embodiment of the invention.

FIG. 7 is a conceptual block diagram of the healthcare expected measure and longitudinal efficiency analysis system and associated process according to an illustrative embodiment of the invention.

FIGS. 8 includes an exemplary list of healthcare provider quality estimates for certain effective care measures according to an illustrative embodiment of the invention.

FIG. 9 is an exemplary graph showing the distribution of diabetes gap score versus supply sensitive score according to an illustrative embodiment of the invention.

FIG. 10 is an exemplary graphical chart showing the ratio of efficiency of hospital A with hospitals B and C for measures such as the number of hospital days, ICU days and physician visits according to an illustrative embodiment of the invention.

### DESCRIPTION OF ILLUSTRATIVE EMBODIMENTS

As described above in the summary, the invention is generally directed to systems and methods that measure unwarranted variations in healthcare treatments and/or measures among certain patient populations to, thereby, enable more efficient, consistent, and cost-effective healthcare service throughout all or a segment of the healthcare system.

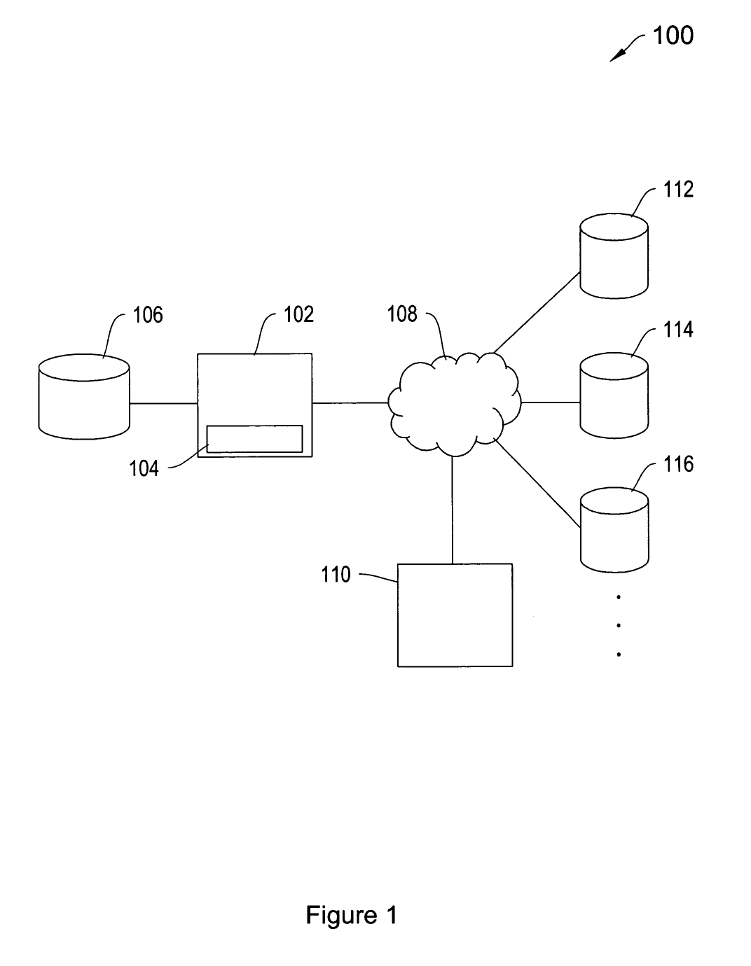

FIG. 1 is a conceptual block diagram of a predictive modeling analytic system 100 for determining longitudinal efficiency measures according to an illustrative embodiment of the invention. The analytic system 100 includes computer system 102, local healthcare database 106, network 108, remote information system 110, and remote healthcare databases 112, 114, and 116. The computer system 102 also includes a predictive modeling application 104.

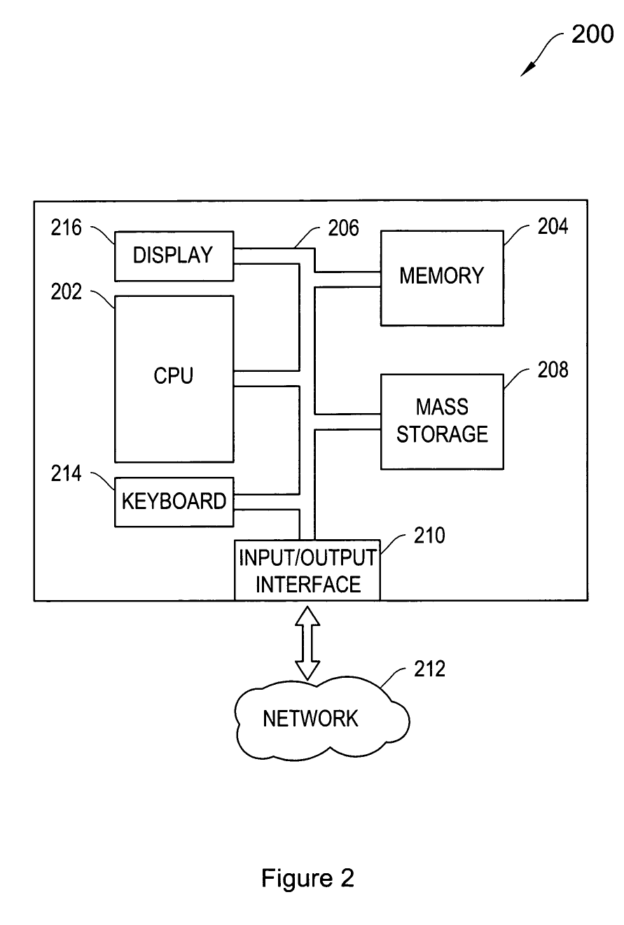

FIG. 2 shows a functional block diagram of general purpose computer system 200 for performing the functions of the computer 102 according to an illustrative embodiment of the invention. The exemplary computer system 200 includes a central processing unit (CPU) 202, a memory 204, and an interconnect bus 206. The CPU 202 may include a single microprocessor or a plurality of microprocessors for configuring computer system 200 as a multi-processor system. The memory 204 illustratively includes a main memory and a read only memory. The computer 200 also includes the mass storage device 208 having, for example, various disk drives, tape drives, etc. The main memory 204 also includes dynamic random access memory (DRAM) and high-speed cache memory. In operation and use, the main memory 204 stores at least portions of instructions and data for execution by the CPU 202.

The mass storage 208 may include one or more magnetic disk or tape drives or optical disk drives, for storing data and instructions for use by the CPU 202. At least one component of the mass storage system 208, preferably in the form of a disk drive or tape drive, stores the database used for processing the predictive modeling of system 100 of the invention. The mass storage system 208 may also include one or more drives for various portable media, such as a floppy disk, a compact disc read only memory (CD-ROM), or an integrated circuit non-volatile memory adapter (i.e. PC-MCIA adapter) to input and output data and code to and from the computer system 200.

The computer system 200 may also include one or more input/output interfaces for communications, shown by way of example, as interface 210 for data communications via the network 212. The data interface 210 may be a modem, an Ethernet card or any other suitable data communications device. To provide the functions of a computer 102 according to FIG. 1, the data interface 210 may provide a relatively high-speed link to a network 212, such as an intranet, internet, or the Internet, either directly or through an another external interface. The communication link to the network 212 may be, for example, optical, wired, or wireless (e.g., via satellite or 802.11 Wifi or cellular network). Alternatively, the computer system 200 may include a mainframe or other type of host computer system capable of Web-based communications via the network 212.

The computer system 200 also includes suitable input/output ports or may use the interconnect bus 206 for interconnection with a local display 216 and keyboard 214 or the like serving as a local user interface for programming and/or data entry, retrieval, or manipulation purposes. Alternatively, server operations personnel may interact with the system 200 for controlling and/or programming the system from remote terminal devices via the network 212.

The computer system 200 may run a variety of application programs and store associated data in a database of mass storage system 208. One or more such applications may enable the receipt and delivery of messages to enable operation as a server, for implementing server functions relating to determining longitudinal efficiency measures using application 104 of FIG. 1.

The components contained in the computer system 200 are those typically found in general purpose computer systems used as servers, workstations, personal computers, network terminals, portable devices, and the like. In fact, these components are intended to represent a broad category of such computer components that are well known in the art. Certain aspects of the invention may relate to the software elements, such as the executable code and database for the server functions of the predictive modeling application 104.

As discussed above, the general purpose computer system 200 may include one or more applications that evaluate healthcare provider performance in accordance with embodiments of the invention. The system 200 may include software and/or hardware that implements a web server application. The web server application may include software such as HTML, XML, WML, and like hypertext markup languages.

The foregoing embodiments of the invention may be realized as a software component operating in the system 200 where the system 200 is Unix workstation. Other operation systems may be employed such as, without limitation, Windows and LINUX. In that embodiment, the healthcare analysis software can optional be implemented as a C language computer program, or a computer program written in any high level language including, without limitation, C++, Fortran, Java or BASIC. Additionally, in an embodiment where microcontrollers or DSPs are employed, the healthcare analysis mechanism can be realized as a computer program written in microcode or written in a high level language and compiled down to microcode that can be executed on the platform employed. The development of such a healthcare provider performance analysis mechanism is known to those of skill in the art, and such techniques are set forth in DSP applications within, for example, but without limitation, the TMS320 Family, Volumes I, II, and III, Texas Instruments (1990). Additionally, general techniques for high level programming are known, and set forth in, for example, Stephen G. Kochan, Programming in C, Hayden Publishing (1983). Developing code for the DSP and microcontroller systems follows from principles well known in the art.

As stated previously, the mass storage 208 may include a database. The database may be any suitable database system, including the commercially available Microsoft Access database, and can be a local or distributed database system. The design and development of suitable database systems are described in McGovern et al., A Guide To Sybase and SQL Server, Addison-Wesley (1993). The database can be supported by any suitable persistent data memory, such as a hard disk drive, RAID system, tape drive system, floppy diskette, or any other suitable system. The system 200 includes a database that is integrated with the system 200, however, it will be understood by those of ordinary skill in the art that in other embodiments the database and mass storage 208 can be an external element such as databases 106, 112, 114, and 116.

Returning to FIG. 1, the predictive modeling application 104, in various embodiments, may employ one or more, or a combination of various types of statistical models to determine expected care measures and/or longitudinal efficiency measures for certain patient populations.

Longitudinal efficiency includes the efficiency of delivery of health care services to a defined population over an extended period of time. In certain embodiments, the longitudinal efficiency measure includes an analysis of unwarranted variations in medical practice. In order to provide a measurement of longitudinal efficiency, certain embodiments of the present invention look to two critical components of the provider quality measurement system: creation of populations and development of robust measures for these populations. In one embodiment, the methodology identifies populations loyal to physician groups and/or hospitals. Embodiments of the measurement system of the invention allow analysis at the individual physician level, at the group level, and at the hospital-medical staff level.

Aspects of the analysis of the present invention are provided below in the context of various embodiments.

Assignment of Loyal Patients: Creating the Denominators

Physician Assignment: In certain embodiments, one step in the measurement process focuses on the usual provider of care. In one embodiment, one of two methods is used to assign patients to primary care physicians (“PCP”): For members within a Health Maintenance Organization (“HMO”), the application 104 assigns them to their selected PCP. For non-HMO patients, the application 104 uses an algorithm using selected claims from the Evaluation and Management (E&M) series of Current Procedural Terminology (“CPT”) codes to create one-to-one patient to provider matches. Further details regarding the algorithm and selection process for patient to provider matches are provided later herein. In one embodiment, this algorithm has been validated through both claims analysis and office-based reviews to have a high level of specificity (>90%). In one embodiment, the step of assignment to a physician/primary care provider is performed as a first step in the analysis because any visit to a primary care provider precedes visit(s) to a specialist. In this embodiment, patients unassigned to a PCP are then assigned to specialists. In another embodiment, the same criteria is used to attribute the patient to additional specialists (e.g., a cardiologist or gastroenterologist).

Hospital Assignment: In certain embodiments, the application 104 may assign patients to specific hospitals. Hospital assignment may, according to one embodiment, be performed using two different denominators. In one embodiment “virtual hospital medical staffs,” each consisting of the group of physicians who most commonly refer and admit patients to a specific hospital or hospital system, are used for the profiling of hospital and physician services, and analysis of admissions among the panel of patients assigned to those physicians is performed. In this embodiment, based on the plurality of hospital admissions among the physician's patient panel, the entire panel may be assigned to an acute care facility and empirically derived hospital loyalty data may be factored in. In this method, all patients, regardless of whether they have been admitted to the hospital, are used in the assessment of provider performance.

In another embodiment, a second level of analysis is based on admitted patients alone. This method may use, for example, an inception cohort model or a follow-back methodology to measure and compare care across providers following an admission. In this embodiment, providers are measured only for those patients using the hospital one or more times. In one embodiment, all patients admitted with specific conditions (e.g., acute myocardial infarction or a hip fracture) are followed after their index admission (i.e., for the specific event—acute myocardial infarction, hip fracture, etc.) to evaluate the frequency and types of contacts with the health care system. In another embodiment, all members/patients who died are identified and the utilization of health care services in the 48 months prior to death are evaluated. Other periods may be evaluated such as periods up to about 60 months, 36 months, 24 months, 12 months, and 6 months. In a preferred embodiment, one key metric for comparing hospital performance is the longitudinal utilization of services post discharge.

Populations: For both physician and hospital level analyses, in one embodiment, the application 104 creates a total population and selected chronic disease and acute care cohorts. The chronic and acute disease cohorts may be useful for a number of reasons, including: (1) As cohorts are clinically defined, performance metrics may be more transparent to clinicians; (2) These cohorts may be used to drive disease specific effective care measures. Therefore, an explicit analysis of the delivery of effective care versus supply-sensitive care can be more readily available within these cohorts; (3) The risk adjustment may thus be more accessible and seem less like a ‘black-box’ to policy makers and clinicians.

Quality and Efficiency Measures: Creating the Numerators

In certain embodiments, the application 104 employs a multi-part taxonomy that is used for categorizing health care services for the purpose of measuring quality and efficiency. In one embodiment, the application 104 uses a three-part taxonomy for categorizing all health care services for the purpose of measuring quality and efficiency. The three factors are: effective care, preference-sensitive care, and supply-sensitive care.

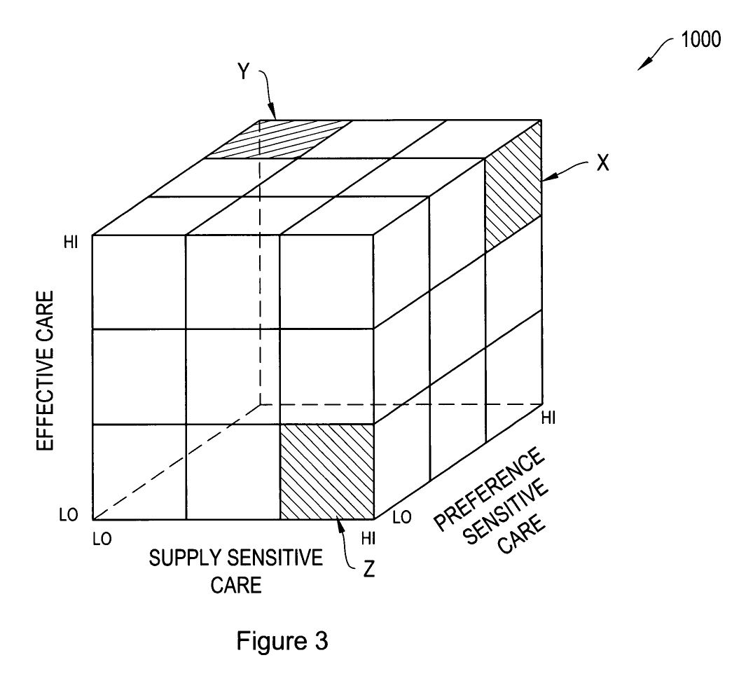

FIG. 3 is a conceptual representation of the combination of effective care, supply sensitive care, and preference sensitive care associated with determining unwarranted variation of healthcare service according to an illustrative embodiment of the invention. FIG. 3 illustrates that the analysis of these three factor can be employed to seek to reduce unwarranted variation in care across all three of these axes. By facilitating assessment of the variation in rates of delivery for various populations, these categories of unwarranted variation can serve as a source of provider performance measurement. In certain embodiments, the three types of unwarranted variation are the basis for provider performance measurement.

As illustrated in FIG. 3, the application 104, in certain embodiments, combines a robust methodology that addresses unwarranted variation in healthcare delivery with user expertise to assist health plans and employers in implementing meaningful change to provider behavior, network structure, payment mechanisms, and patient satisfaction.

In certain embodiments, the application 104 obtains measures of performance across the three categories of unwarranted variation outlined above. These measures can provide an understanding of the drivers of this variation as well as insights for creating interventions that can reduce unwarranted variations, thereby improving the quality of services, improving patient satisfaction, and improving patient outcomes. In one embodiment, the application 104 measures provider performance across these categories to deliver a comprehensive picture of value and to identify business opportunities for economic leverage.

Unlike other metrics proposed to measure provider quality and efficiency, the population-based measures according to various embodiments captures both the decisions about which types of treatment are being recommended and the efficiency of the delivery of these services after that decision has been made. These measures, in certain embodiments, incorporate either or both facility services (such as, for example, use of ER or hospital) and professional services (such as, for example, physician visits, consults, or use of imaging studies or laboratory studies).

Effective care: Effective care includes care that has proven clinical effectiveness —for example, from randomized, controlled trials or well constructed observational studies. Effective care measures can be both condition specific (e.g., use of angiotensin converting enzyme/angiotensin receptor blockers (“ACE/ARB”) inhibitors in members with diabetes and hypertension), and age-gender specific (e.g., mammogram use in women ages, 50 to 65). Table 1 shows an example of selected measures and/or predictors for diabetics. While Table 1 provides an exemplary table of selected measures according to one embodiment, any or all of the boxes in Table 1 may be selected and include other measures in other embodiments of the invention.

TABLE 1

| | | | Physician- | |
|---|---|---|---|---|
| Effective Care | Physician | Physician | Hospital | Hospital (Index |
| Measures for | Level | Group | Level | Admission) |
| Diabetes | Analysis | Analysis | Analysis | Level Analysis |
| HgbA1c | ✓ | ✓ | ✓ | ✓ |
| Testing | | | | |
| Lipid Screening | ✓ | ✓ | ✓ | ✓ |
| Lipid Treatment | ✓ | ✓ | ✓ | ✓ |
| in members | | | | |
| with Concurrent | | | | |
| CAD | | | | |
| ACE/ARB in | ✓ | ✓ | ✓ | ✓ |
| members with | | | | |
| concurrent | | | | |
| HTN | | | | |

Other typical measures of effective care may include: 1) Adherence to beta blockers for patients with coronary artery disease; 2) Rate of ACE/ABR Prescriptions for patients with diabetes and hypertension; and, 3) Rate of Breast Cancer Screening for Women.

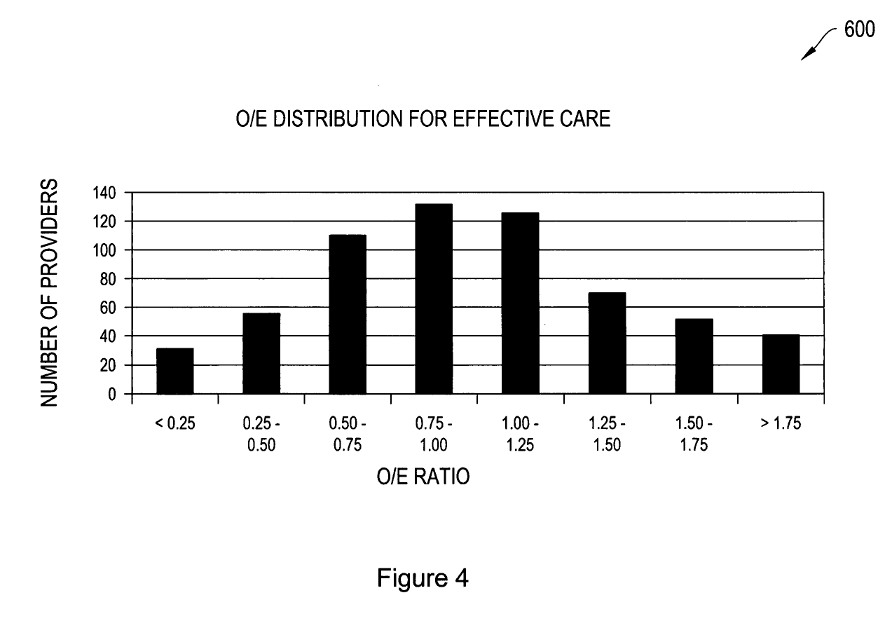

FIG. 4 is an exemplary graphical chart showing the distribution of variations in effective care for healthcare providers at various ranges of the ratio of the number of observed (O) to expected (E) members receiving a screening measure according to an illustrative embodiment of the invention. As illustrated in FIG. 4, the majority of providers include observed (O) numbers of measures that are close to the expected (E) number of measures based on the predictive model. However, a portion of the providers have O/E ratios outside of, for example, the 0.75-1.25 ratio ranges which may be considered to include excessive unwarranted variation in healthcare service. Thus, these providers may be targeted for incentive programs, training, and review to improve their longitudinal efficiency with respect to effective care for one or more types of treatment and/or measures.

Preference-sensitive care: Preference-sensitive care includes care for which there are significant tradeoffs in terms of risks and benefits for the patient. The choice of care is, or should be, driven by the patient'sown preferences. In certain embodiment, several preference sensitive measures can be used. The total measures in the physician and hospital denominators may vary based on sample size. For each measure, in certain embodiments, the application 104 creates age-sex adjusted rates of use of selected measures. Table 2 shows an example of selected measures for each of the three denominators used according to an illustrative embodiment. While Table 2 provides an exemplary table of selected Preference Sensitive Conditions according these embodiments, any or all of the boxes in Table 2 may be selected and include other measures.

TABLE 2

| Preference | Physician | Physician | Physician- | Hospital (Index |
|---|---|---|---|---|
| Sensitive | Level | Group | Hospital Level | Admission) |
| Condition | Analysis | Analysis | Analysis | Level Analysis |
| Low Back | ✓ | ✓ | ✓ | ✓ |
| Condition | | | | |
| Benign Uterine | * | ✓ | ✓ | ✓ |
| Conditions | | | | |
| Prostate Cancer | ✓ | ✓ | ✓ | ✓ |
| Screening | | | | |
| Prostate Cancer | * | ✓ | ✓ | ✓ |
| Treatment | | | | |
| Hip and Knee | * | ✓ | ✓ | ✓ |
| Conditions | | | | |
| Cardiac | * | ✓ | ✓ | ✓ |
| Revas- | | | | |
| cularization | | | | |
| Breast Cancer | * | ✓ | ✓ | ✓ |
| Treatment | | | | |

* In certain instances, the counts may or may not be too small for stable estimates, but may be assessed.

Other embodiments may use other measures for preference-sensitive care. For example, these may include the choice between lumpectomy and mastectomy for women with early stage breast cancer, or medical versus operative management of patients with sciatica. In other embodiments, the preference sensitive care measure may more particularly include the rate of Prostatectomies for men with benign prostatic hypertrophy and/or the rate of Hysterectomies for benign uterine conditions.

Supply-sensitive care: Supply-sensitive care is strongly correlated with health care system resource capacity. Unlike effective care, for supply-sensitive care the presence of medical evidence and clinical theory to guide the delivery of supply-sensitive care may be weak or non-existent. Unlike other metrics proposed to measure efficiency, a population-based measure according to certain embodiments can capture both the decisions about the type of treatment being recommended, as well as the efficiency of the delivery of these services after that decision has been made. These measures, in various embodiments, include either or both facility services(such as, for example, ER or hospital use) and professional services (such as, for example, visits, consults, or use of imaging studies or laboratory studies). For the latter, a in one embodiment, the application 104 groups the CPT codes into several mutually exclusive groups. Table 3 shows an example of selected measures for each of the three denominators used in certain embodiments. While Table 3 provides an exemplary table of selected Supply Sensitive Conditions according to certain embodiments, any or all of the boxes in Table 3 may be selected and include other conditions in other embodiments.

TABLE 3

| Supply | Physician | Physician | Physician- | Hospital (Index |
|---|---|---|---|---|
| Sensitive | Level | Group | Hospital Level | Admission) |
| Condition | Analysis | Analysis | Analysis | Level Analysis |
| Imaging | ✓ | ✓ | ✓ | ✓ |
| Studies | | | | |
| Laboratory | ✓ | ✓ | ✓ | ✓ |
| Services | | | | |
| Visit Rates | ✓ | ✓ | ✓ | ✓ |
| Visit Interval | ✓ | | | |
| Emergency | ✓ | ✓ | ✓ | ✓ |
| Room Visits | | | | |
| Hospital | ✓ | ✓ | ✓ | ✓ |
| Admissions | | | | |
| Readmission | * | ✓ | ✓ | ✓ |
| Ratio | | | | |
| End-of-life | * | ✓ | ✓ | ✓ |
| Care | | | | |
| Total Care | ✓ | ✓ | ✓ | ✓ |
| Intensity | | | | |

* In certain instances, the counts may or may not be too small for stable estimates, but may be assessed.

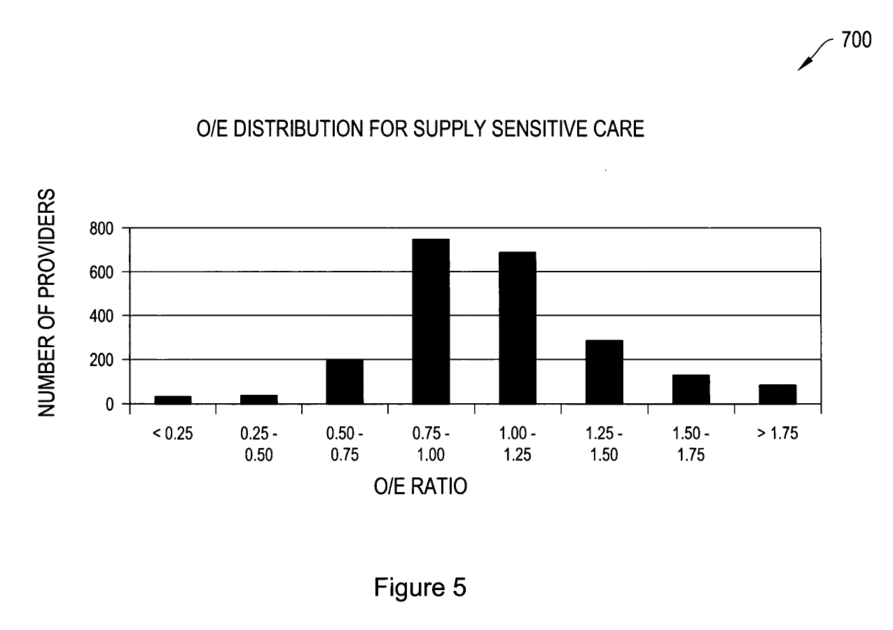

FIG. 5 is an exemplary graphical chart showing the distribution of variations in supply sensitive care for healthcare providers at various ranges of the observed (O) to expected (E) ratio for members that received supply sensitive care according to an illustrative embodiment of the invention. As illustrated in FIG. 5, the majority of providers include observed (O) numbers of measures that are close to the expected (E) number of measures based on the predictive model. However, a portion of the providers have O/E ratios outside of, for example, the 0.75-1.25 ratio ranges which may be considered to include excessive unwarranted variation in healthcare service. Thus, these providers with may be targeted for incentive programs, training, and review to improve their longitudinal efficiency with respect to effective care for one or more types of treatment and/or measures.

The application 104, in certain embodiments, applies predictive and/or statistical methods and models to take into account case mix (adjusting for the mix of patients seen by a physician) and/or severity (adjusting for the severity of individual patients seen by a physician) across provider panels.

Reporting the Measures

Effective care: According to certain embodiments, results for effective care measures may be the cohort specific rates of use of the effective care measures. Because these measures have a normative correct rate (100%), they may not be age or risk adjusted. However, in certain embodiments, results may be calculated with or without accounting for clustering within practices and hospitals. For measures that are not annual or biannual events (such as lipid testing for members without coronary artery disease or diabetes), the application 104 may compare the use across providers. In one embodiment, these are expressed as estimated rates (adjusted for the observation time).

In addition to the individual measures, in one embodiment, the application 104 calculates an effective care index using a weighted scoring algorithm. In another embodiment, the application 104 assigns Clinical gap weights associated with the potential impact of the clinical gap on morbidity and mortality. Clinical gap weights may be derived in various ways, including empirically or by an expert panel that provide input to the Application 104. In one embodiment, this process involves a two step assessment of the risk to the member if the gap is not closed. In step 1, each member of the panel independently assigns a weight. In step two, the distribution of weights are considered and, through a consensus process, a single weight is assigned by all members of the panel. As each gap is identified, a literature search may be performed to evaluate evidence that closing the gap will improve morbidity or mortality. Once this is ascertained, a process, using a modified Delphi technique, may be performed to give the gap a relative weight. The higher the weight, the more important it is to close the gap to reduce the risk of harm to the patient. The weights may be used to assess, for each measure, the clinical risk for the member of not having the effective care opportunity met. This “gap score ” may be calculated for each provider'schronic member populations.

Preference-sensitive care: For the preference-sensitive measures, in one embodiment, the application 104 calculates provider specific age-sex adjusted procedure-specific utilization rates. According to various embodiments, these results may be calculated with or without accounting for clustering within practices and hospitals.

Supply-sensitive care: For supply-sensitive measures, in certain embodiments, the application 104 calculates the utilization rates or measures of intensity of care, or both. Utilization rates may be calculated for such measures as physician, ER and hospital visits. Intensity measures may be calculated for specific services such as imaging studies or laboratory services, or may represent total intensity measures. Because the price paid per unit varies over time and across products, price-insensitive measures may be calculated, and these results may be expressed as intensity of services and/or as costs. For professional services, these may be based on such factors as procedure specific resource value units (RVUs); for facility-based services, these may be based on such factors as the event specific case-mix-index (CMI). For each, in some embodiments, the application 104 applies a constant (average dollars per RVU and average dollars per case-mix-index) to arrive at a total intensity measure.

Statistical Analysis

Risk-adjustment: For selected measures and populations, the application 104 may perform a risk-adjustment using any one of a variety of risk adjustment methods. In one embodiment, a version of the Charlson Index may be employed that applies the factors identified by the Charlson Index and develops specific weights for each population-level data set. (See Charlson et al., A new method of classifying prognostic comorbidity in longitudinal studies: development and validation. J Chron Dis, 40(5), 373-383 (1987)). The Charlson Index is considered a validated instrument used for risk adjustment in hospital-based outcomes and has been used in several non-hospital based outcomes studies. In other embodiments, one or more other validated instruments may be employed separately or in combination with the Charlson Index. In another embodiment, a version of the Center for Medicaid and Medicare Service's risk adjustment method may be employed with population-specific weights applied. In one embodiment, this method, based on diagnostic clusters, may be expanded to include the conditions not typically present in an older population. A description of various risk adjustment models is provided in the Diagnostic Cost Group Hierarchical Condition Category Models for Medicare Risk Adjustment Report (See Pope et al., Diagnostic Cost Group Hierarchical Condition Category Models for Medicare Risk Adjustment: Final Report, Health Care Financing Administration (2000)).

Modeling: The application 104, in certain embodiments, uses mixed models (e.g., without limitation, linear, logistic and Poisson) to estimate physician and hospital rates of effective, supply sensitive, and preference sensitive care. A mixed model can permit direct prediction of individual physician effects on patient outcomes taking into account, for example, the characteristics of his/her patient population. With the patient as the unit of analysis, a mixed model can account for clustering of patients within physicians, and physicians within hospital medical staffs, using patient characteristics for risk adjustment. In addition, a mixed model methodology can account for different amounts of information available on physicians (different patient numbers) in an optimal way. In embodiments of the invention, collective information on medical staffs can be used to reduce errors when little information is available on an individual physician. For those physicians with many patients, more accurate predictions of physician performance can be obtained.

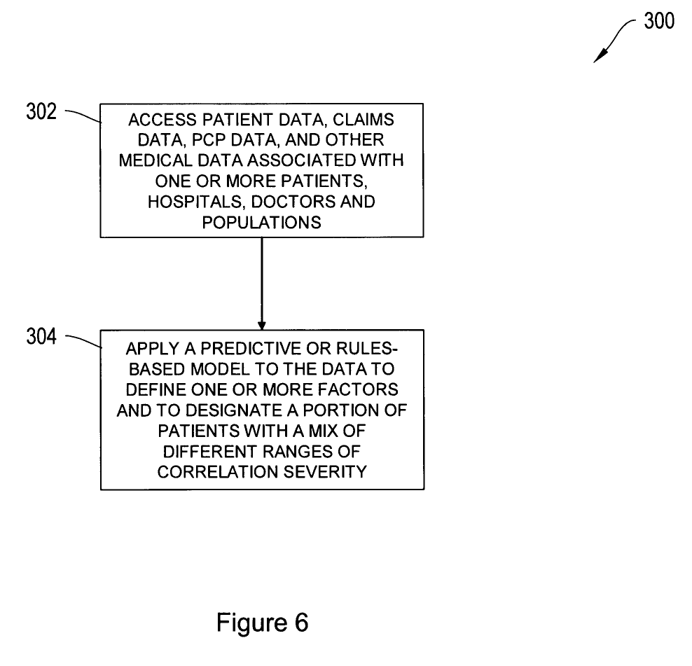

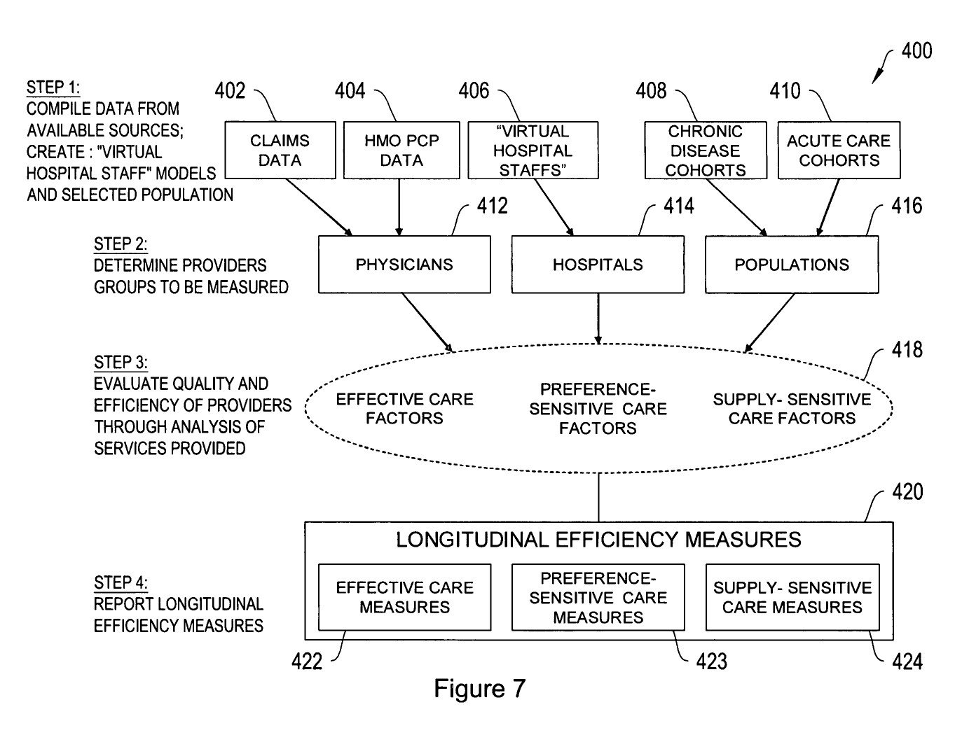

FIGS. 6 and 7 are a flow and conceptual diagrams, respectively, of an exemplary longitudinal efficiency analysis process 300 and system 400 according to an illustrative embodiment of the invention. In operation in certain embodiments, the software application 104 performs the following. The application 104 accesses and/or retrieves patient-related data such as claims data 402, HMO PCP Data 404, Virtual hospital staff data 406, chronic disease cohorts 408, acute care cohorts 410, and any other relevant patient data associated with one or more patients, hospitals, physician, or patient populations (Step 302). The various patient related data 402-410 may reside within an internal database 208, local database 106, or a remote database 112, 114, and 116. The remote databases 112, 114, and 116 may be accessible via a communications network 108 including, for example, any one or combination of the Internet, an internet, an intranet, a local area network (LAN), wide area network (WAN), a wireless network, and the public switched telephone network (PSTN). Each of the remote databases 112, 114, and 116 may be associated with a public and/or private healthcare database including patient specific information, general healthcare information, general demographic information, and/or other information relevant to the longitudinal efficiency analysis process 300.

FIG. 6 is a flow diagram of an exemplary longitudinal analysis process 300 according to an illustrative embodiment of the invention. The application 104 applies a predictive model to the patient related data to identify a set of healthcare measures and/or predictors that are related to the healthcare measure and/or treatment that would be expected to be implemented by a healthcare provider (Step 310). The application 104 may output the measures and/or treatments in the form of a data file that may be delivered to a local user interface and/or display 216 or to a remote information system 110 for further processing and/or viewing.

In one embodiment, the predictive model may output a list of measures with associated weights to enable a panel of experts to determine which measures should be used to determine when a related healthcare measure is expected. In another embodiment, the panel of expert may independently identify a set of predictors associate with an expected measure that are then submitted to the application 104 for processing. In certain embodiments, a threshold score or weight may be defined to enable the application 104 to automatically identify a set of measures and/or predictors that can be used to determine when a certain healthcare measure and/or treatment is expected. In a further embodiment, a retrospective analysis of previous patient populations may be used to identify those measures that should be used to determine whether a particular healthcare measure is expected. In certain embodiments, a combination of a statistical analysis and expert panel decisions may be employed to define the measures and/or predictors associated with one or more expected measures.

In another embodiment, a Boolean expression or decision tree may be employed to determine whether a particular measure is expected. For example, a rule set may be associated with measure Y wherein if measures A, B, and C are present, then measure Y is expected. Measures A and B may be comorbidities while C is a contraindication. Thus, once a rule set is established, the patent related data associated each patient within a certain population can be compared with the rule set to determine whether the measure Y was expected for each patient. The total number of expected measures Y can then be compared with the total number of observed (O) measures to obtain a longitudinal efficiency measure. As discussed previously, the efficiency measures can be made across categories of care such as effective care, preference-sensitive care, and supply-sensitive care.

FIG. 7 is a conceptual block diagram of the expected measure and longitudinal efficiency analysis system 400 and associated process according to an illustrative embodiment of the invention. The system 400 includes one or more data sources such as, without limitation, claims data 402, HMO PCP Data 404, Virtual hospital staff data 406, chronic disease cohorts 408, acute care cohorts 410, and any other relevant patient data associated with one or more patients, hospitals, physician, or patient populations. The system 400 includes one or more patient population groups such as, without limitation, physicians 412, hospitals 414, and other regional, national, global, demographic, occupational, or other segmented populations 416. The system 400 may include an evaluator function 418 that segments or categorize the evaluation process into at least three categories such as, without limitation, effective care, preference-sensitive care, and supply-sensitive care. The system 400 may include an output function 420 that provides various measures of longitudinal efficiency based on, without limitation, effective care measures 422 , preference-sensitive care measures 423, and supply-sensitive care measures 424.

In operation, the system 400 determines the longitudinal efficiency of one or more healthcare providers as follows. First, the system 400 compiles patient related data form one or more sources 402, 404, 406, 408, and 410 (Step 1). The system 400 may create one or more virtual hospital staffs 406 associated with a selected patient population. Then, the system 400 determines and/or defines one or more patient populations based on, for example, one or more physicians 412, one or more hospitals 414, and/or one or more other populations 416 (Step 2). Any portion of the sources 402-410 may be used as input for any one of the populations 412, 414, and 416. The system 400 evaluates the quality and efficiency of the healthcare providers through an analysis of the services provided (Step 3). For example, as discussed above, the analysis may include a determination of the unwarranted variation of healthcare service associated with one or more healthcare measures. Finally, the system 400 reports the longitudinal efficiency measures (Step 4). The report may include one or more lists of analyzed healthcare measures, comparisons of the healthcare provider's performance to other healthcare providers, one or more recommended approaches for reducing unwarranted variations, and other like information. The system 400 may employ a software application such as application 104 to perform the various steps and/or includes the various functions associated with measuring longitudinal efficiency. More particularly, the application 104 may access patient data 402-410 associated with a patient population, apply a predictive model to the patient data to determine the number of times that a healthcare measure is expected to occur, access the patient data 402-410 to determine the number of times that the healthcare measure occurred, and compare the number of times that the measure occurred with the number of time that the measure was expected to occur to identify the unwarranted healthcare service variation.

While FIG. 7 provides an exemplary flowchart for measuring longitudinal efficiency, numerous variations in input data may include without limitation other data, populations, cohorts, groups, evaluations, analyses, measures and reports. The claims data may include, without limitation, claims (e.g., professional, facility, pharmacy, enrollment); laboratory data; and member survey data on risk and functional status, among other standard claims information. In certain embodiments, the various steps and functional elements of system 400 are performed, at least in part, by the application 104, a related application, manually by a panel of healthcare professionals, or a group of applications that operate cooperatively over a data communications network.

In one embodiment, the application 104 creates reports where each efficiency measure may be reported for the entire panel and stratified by specific population subsets. The number of patients included in the score is displayed along with the observed (O) and expected (E) values used to calculate the score. These observed (O) and expected (E) values may also be displayed as population-based rates. The efficiency score may be reported with a corresponding confidence interval (CI). In a preferred embodiment, this may include a 95% confidence interval (CI). In certain embodiments, the CI is calculated using, without limitation, a Poisson model, Poisson regression model, a negative binomial model, or like statistical model. In one embodiment, a maximum likelihood estimation (MLE), goodness-of-fit, or best fit estimation is applied to the O and E data to derive the Poisson estimated distribution and, thereby, derive at least one of a 90%, 95%, 98%, and 99% CI.

The following exemplary Poisson function may be employed by the application 104, at least in part, to derive the CI. The application 104 may perform an iterative, regressive, and/or repetitive estimation process to achieve a maximum likelihood estimation of a Poisson distribution that characterizes the observed (O) to estimated (E) measure ratio. The following is a standard Poisson distribution function.
Fₚ(X)=e^{-a}e^{x}/X! (1)
Where:
a=mean
\sqrt{a}=standard deviation
X=number of members of a population

In one embodiment, the application 104 employs a numerical analysis and/or regression process to find the MLEs. For example, the application 104 makes an initial estimate of the parameters which include the mean and standard deviation. The application 104 computes the likelihood of the distribution based on the parameters. Then, the application 104 improves and/or adjusts the parameter estimates to a certain degree and re-calculates the likelihood of the distribution fitting the O and E data. The application 104 continuously performs this likelihood estimation for a number of iterations and/or until the parameter changes are below a minimum amount. In certain embodiments, the maximum number of iterations is greater than or equal to about 50, about 100, about 200, about 500, and about 1000. In other embodiments, the MLE proceeds by iteratively re-weighting least squares, using a singular value decomposition to solve the linear system at each iteration, until the change in within a specified deviance or likelihood ratio. The deviance may be derived, for example, using the following equation:

$$Deviance = 2 {\sum }_{i = 1}^{n} {X}_{i} ln ( \frac{{X}_{i}}{{a}_{i}} ) ( {X}_{i} - {a}_{i} ) \qquad ( 2 )$$

Other known techniques may be employed to derive the deviance. By applying an MLE to determine the best fitting Poisson distribution, the application 104, in one embodiment, determines the CI at certain percentages. Based on the estimated distribution, color-coded text may also be used to indicate which scores significantly differ from those expected. In addition, score values that are considered outliers may be highlighted.

It is important to express CIs with the results of statistical analyses because they may convey more information than the probability values alone. The confidence level sets the boundaries of a confidence interval, which is often set at 95% to coincide with the 5% convention of statistical significance in hypothesis testing. In certain embodiments, a wider (e.g. 90%) or narrower (e.g. 99%) CI is calculated. In one embodiment, the CI is defined as the range Q−X to Q+Y where Q is the O/E for a particular measure, Q−X is the lower confidence limit and Q+Y is the upper confidence limit. A 95% CI means that the application 104 is 95% certain that the O/E value will be consistent with an estimated O/E value from a study using a significantly larger population. The O/E value may be a mean, a difference between two means, a proportion of the mean, and the like. In certain embodiments, the CI is symmetrical about the O/E value. The application 104 may employ at least one of a Bayesian, Frequentist, and Neymanian concept in determining the CI.

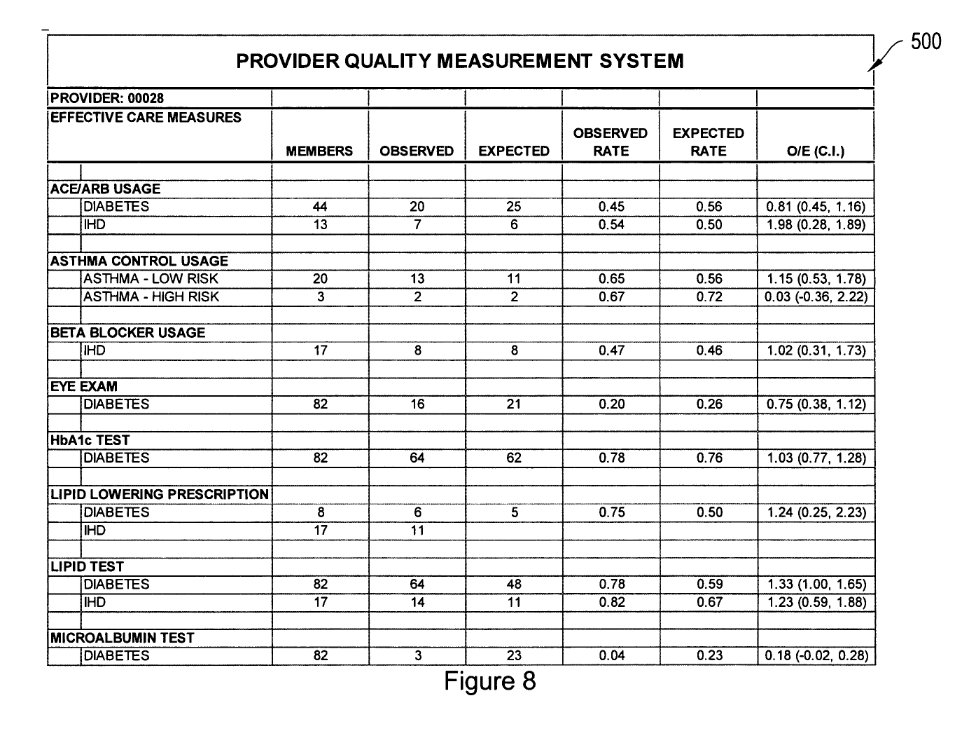

FIGS. 8 includes an exemplary list 500 and/or report of healthcare provider quality estimates and/or longitudinal efficiencies for certain effective care measures according to an illustrative embodiment of the invention. The list 500 includes a plurality of healthcare measures such as Eye Exam and Lipid Test. The list 500 shows the members of a target population which may be defined as discussed previously. Of the defined population, a portion of the members where the measure was observed and was expected are listed. An observed rate and expected rate are derived from the observed to member ratio and expected to member ratio respectively. The O/E in the exemplary list 500 is the ratio of the observed rate to the expected rate. The O/E column includes the CI having an upper and lower bound at a 95% confidence interval.

The list and/or report 500 may include effective care measures for chronic conditions and be representative of the data available. Each measure is identified in bold with relevant populations. The fields are defined as follows:

Members: The number of members in the provider's panel eligible for the indicated measure.

Observed: The number of eligible members receiving the indicated measure.

Expected: The number of eligible members expected to receive the indicated measure after adjusting for the provider's case mix and severity.

Observed Rate: The proportion of eligible members receiving the indicated measure.

Expected Rate: The proportion of eligible members expected to receive the indicated measures after adjusting for the provider's case mix and severity.

O/E (C.I.): The ratio of observed to expected results along with a 95% confidence interval. A value greater than 1 indicates more eligible members receiving the measure than were expected. A value less than 1 indicates fewer eligible members receiving the measure than were expected. The confidence interval displays an upper and lower bound for the O/E value. CIs that do not include 1, in certain embodiments, are considered statistically significant.

In certain embodiments, the O/E ratio is representative of the unwarranted variation in healthcare service for one or more healthcare providers and/or a particular population. In other embodiments, the unwarranted variation is the difference (either positive or negative) between the observed and expected occurrences of a measure or the distance in the number of occurrences, or some other like representation of the variation. In certain embodiments, a color-coded scheme may be employed in the report 500 to highlight certain results. For example, in one exemplary list and/or report 500, the follow color coding scheme is employed:

Gray text: This measure did not include a large enough sample size to draw reasonable conclusions.

Green text: Performance on this measure is significantly higher than expected.

Red text: Performance on this measure is significantly lower than expected.

Yellow highlight: Performance on this measure is considered an outlier.

Other color schemes, backgrounds, fonts, and like visual indicators may be employed to identify the significance of the indicated results.

To assist health plans and employers in fully utilizing the performance measurements, the reports, such as report 500 described above, may be used to define actions that can be taken to achieve the healthcare efficiency goals of clients. In addition, the above described report 500 may provide clinical insights to change management skills and expertise, which can enable more effective expansion of a purchasing agenda based on value (“Value Based Purchasing Agenda”).

In certain embodiments, application 104 and associated processes can assist in achieving outcomes that advance the Value Based Purchasing Agenda, such as:
Improving Network Design and Management—identifying high performance providers and interventions that may increase their use over low performing providers;
Improving Quality and Cost Performance—working with all providers to improve quality of care in all three categories of unwarranted variation and resource allocation, which may result in declining per person costs;
Managing Benefit Plan Design—creating incentives that may lead patients using inefficient providers to choose the “preferred provider,” further decreasing the per person costs.

In certain embodiments,through the use of analysis of unwarranted variation, the application 104 provides a population-based approach to measuring, evaluating, and identifying efficient healthcare providers. The application 104 and its associated longitudinal efficiency analysis system 400 can enable clients to build incentives to sustain efficient behavior, motivate members to utilize efficient providers, and encourage inefficient providers to emulate the “best practices” of efficient providers.

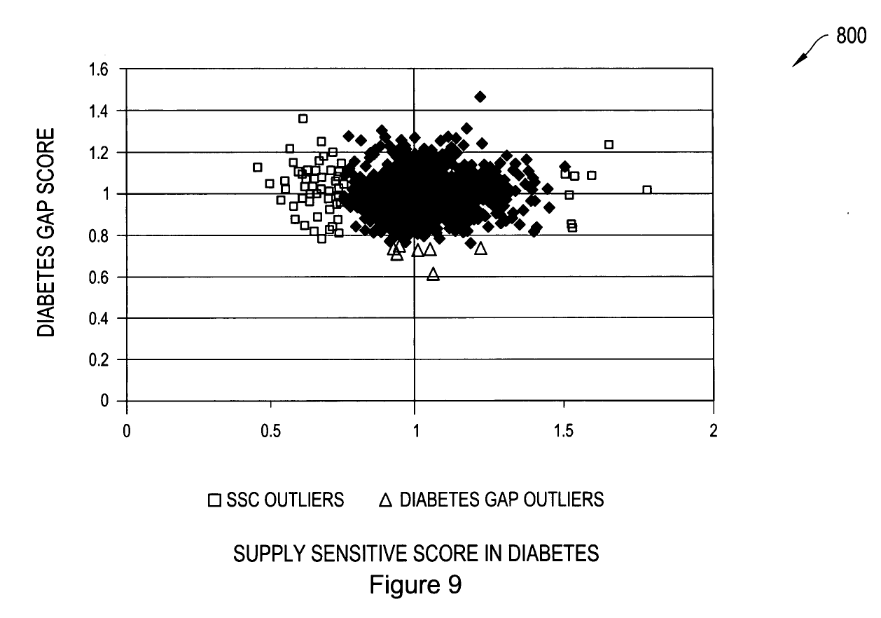

FIG. 9 is an exemplary graph 800 showing the distribution of diabetes gap score (quality) versus supply sensitive score (efficiency) according to an illustrative embodiment of the invention. The exemplary graph 800 illustrates the estimated longitudinal efficiency of physicians for patients with diabetes and the relationship between their efficiency and quality using their gap scores.

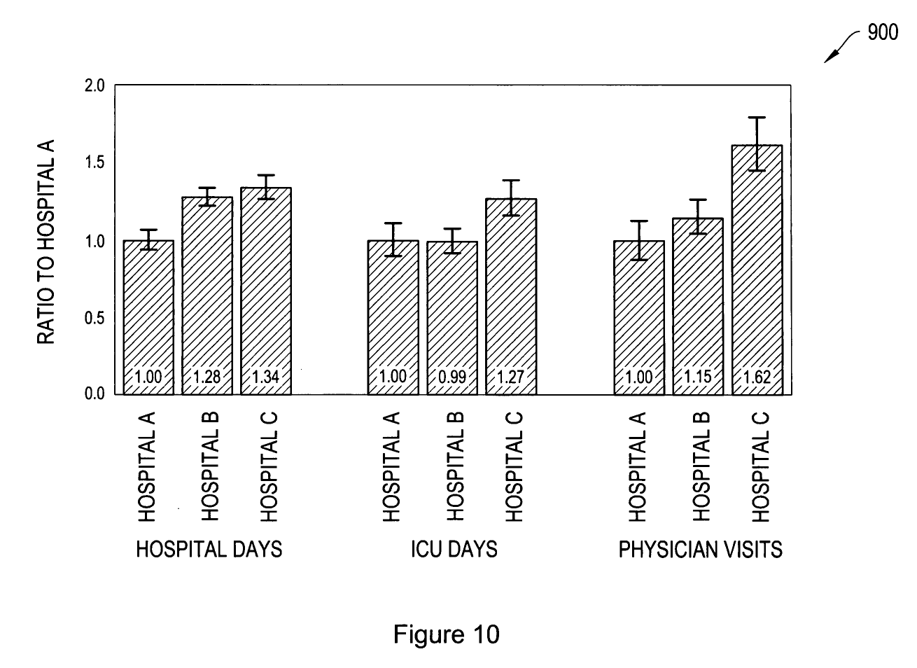

FIG. 10 is an exemplary graphical chart showing the ratio of efficiency of hospital A with hospitals B and C for measures such as the number of hospital days, ICU days and physician visits according to an illustrative embodiment of the invention. In certain embodiments, the longitudinal efficiency measures of one population are compared with the efficiency measures of other populations to provide a measure of the relative performance of, for example, one hospital with respect to other hospitals. In certain embodiments, the application 104 compares one or more of physicians, practices, regions, and any other designated patient populations to provide a relative measure of longitudinal efficiency for the select population and it'sassociated healthcare provider or providers.

In other embodiments, one or more primary care provider (PCP) practices or other physician specialties can be attributed to and/or associated with members enrolled in plans not requiring PCP selection. In one embodiment, a primary purpose for attribution is to be able to notify PCPs that a Health Coach has had contact with one of their chronic patients for the first time and to notify PCPs of potential opportunities to improve care for these members.

In certain embodiments, application 104 algorithms that are used to associate a physician's practice with members in insurance products not requiring selection of a PCP need to balance two issues:
Sensitivity—the goal to attribute as many members as possible to a physician's practice and,
Specificity—the need to assure that those members assigned are truly being cared for by the attributed physician's practice
   In one embodiment, the application 104, based on analysis of utilization patterns and the makeup of primary care and specialty utilization in client populations, employs an attribution rule based on three decision rules:
1. Members who were seen face-to-face by only one PCP/physician practice (e.g., internist, general practitioner, family practitioner or pediatrician) during a 12-month period and seen more than once in this period are attributed to that practice.
2. Members who do not qualify under rule 1, but had one visit in a 12-month period to a PCP practice and two or more visits to one and only one PCP/physician practice within an 18-month period, are attributed to that practice.
3. Members who do not qualify under rules 1 or 2, but had at least one visit in an 18-month period to a PCP practice, are attributed to the PCP/physician practice seen most frequently in this period or, in the case of a tie, to the most recently visited provider.
   The attributed PCP/physician may be summarized as the practice that was:
(A) Seen two or more times in the most recent 12-month period and was the only provider seen; or
(B) Seen two or more times in the most recent 18-month period with at least one visit in the most recent 12-month period and was the only provider seen; or, in cases not meeting either of the above criteria,
(C) Seen most often in the most recent 18-month period. In the case of a tie, the attributed PCP/physician is the most recently visited practice. If the most recent visits to each practice were on the same day, the next most recent set of visits is compared, up to the fourth set of visits. If a most recent visit cannot be selected, no practice is attributed.

An alternative embodiment, based on the analysis of utilization patterns and the makeup of primary care and specialty utilization in client populations, includes an attribution rule based on the recency of visits and required follow-up period. Members are attributed to physicians seen most often face-to-face during a minimum of a 12 month period. The period for which they are attributed will allow measurement over a duration of eligibility of approximately 12 months. In other embodiments, the period may be at least 6 months, at least 9 months, at least 18 months, and at least 24 months. PCP/physician Attribution Methods

In certain embodiments, the application 104 uses a set of definitions for population, claims, and provider specialty that are applied across all of the development and testing processes. Examples of these embodiments are described as follows:
Population Included in the Analyses: In one embodiment, members with one or more chronic conditions are included in the analysis. Examples of chronic conditions may include, without limitation, diabetes, congestive heart failure, chronic obstructive pulmonary disease, coronary artery disease, and asthma.

Claims Used for Attribution: In one embodiment, for all or a portion of analyses, the application 104 uses only claims with the following E&M procedure codes for face-to-face office visits. Other codes and/or designations may be employed and/or added to the following list in Table 4.

TABLE 4

| CPT code | Description |
|---|---|
| 99201 | New Patient: Self Limited |
| 99202 | New Patient: Expanded/Straight Forward |
| 99203 | New Patient: Detailed/Low Complexity |
| 99204 | New Patient: Comprehensive/Mod. Complexity |
| 99205 | New Patient: Comprehensive/High Complexity |
| 99211 | Established Patient: Minimal |
| 99212 | Established Patient: Self Limited |
| 99213 | Established Patient: Expanded/Low Complexity |
| 99214 | Established Patient: Detailed/Moderate Complexity |
| 99215 | Established Patient: Comprehensive/High Complexity |
| 99381 | Initial Comprehensive Preventive Med/Ages <1 |
| 99382 | Initial Comprehensive Preventive Med/Ages 1-4 |
| 99383 | Initial Comprehensive Preventive Med/Ages 5-11 |
| 99384 | Initial Comprehensive Preventive Med/Ages 12-17 |
| 99385 | Initial Comprehensive Preventive Med/Ages 18-39 |
| 99386 | Initial Comprehensive Preventive Med/Ages 40-65 |
| 99387 | Initial Comprehensive Preventive Med/Ages 65+ |
| 99391 | Periodic Comprehensive Preventive Medicine/Ages <1 |
| 99392 | Periodic Comprehensive Preventive Medicine/Ages 1-4 |
| 99393 | Periodic Comprehensive Preventive Medicine/Ages5-11 |
| 99394 | Periodic Comprehensive Preventive Medicine/Ages 12-17 |
| 99395 | Periodic Comprehensive Preventive Medicine/Ages 18-39 |
| 99396 | Periodic Comprehensive Preventive Medicine/Ages 40-65 |
| 99397 | Periodic Comprehensive Preventive Medicine/Ages65+ |

In certain embodiments, medical claims may be unduplicated (i.e., duplicates may be eliminated) by such attributes as member ID, provider ID and service date. For each analysis according to one embodiment, the application 104 uses the most recently available claims and may not attempt to control for claims run-out, operating on the principle that the method should reflect the real world application of the recommended targeting strategy.

Provider Specialty

In certain embodiments, the application 104 limits analyses to visits to primary care specialties (e.g., family and general practice, internal medicine and pediatrics) or to other medical specialties (e.g., cardiology or gastroenterology). In another embodiment, the application 104 classifies multi-specialty practices that include primary care practitioners as primary care practices. This assignment of primary care versus specialty care may be done at the servicing provider level. Claims may then be summed at the billing provider level. Total number of claims and unique providers may be counted over the most recent 12 and/or 18-month periods.

Using the methods described above, the application 104 may also complete a process to validate Physician Attribution for the Client PPO population by various methods, including:

Algorithm testing on a comparative HMO/POS data set by, in one embodiment, testing the algorithm in a PPO product and comparing it against a HMO/POS data set from the same health system; and/or

Verification of algorithms on the overall Client PPO Populations (including analysis of client-specific primary care and specialty utilization)

In certain embodiments, the case mix and severity is determine by a statistical analysis of the severity of a condition. For example, FIG. 8 shows a listing of effective care measures for diabetes (and other conditions). In one embodiment, a risk event analysis is performed on the patients based on their medical histories to determine the severity of their condition (diabetes) and, therefore, to determine the E expected measures that should have been utilized for each member of the mix of diabetes patients. Further details regarding a risk event analysis and an associated logistic regression analysis are provided in U.S. patent application Ser. No. 11/280,611 and U.S. patent application Ser. No. 11/281,233, both filed on Nov. 16, 2005, the entire contents of which are incorporated herein by reference.

For example, even though there may be a population of 82 patients with diabetes, only 5 patients would be expected to need Lipid Lowering Prescription while only 21 would be expected to need an Eye Exam. Then, a comparison is made between the expected with the observed to quantify the unwarranted variation. In certain embodiments, the comorbidities and contraindications are considered factors and/or predictors of an expected measure. In certain embodiments, a measure can be a predictor for another measure. These predictors and/or factors may be assigned gap scores (weights) by a medical panel of experts based on, for example, a modified Delphi technique. In certain embodiments, the panel uses the weights from a statistical analysis along with their expert opinions to define the predictors for an expected measure.

In certain embodiments, the application 104 measures unwarranted variations among various providers (or other groups). Thus, the application 104 may be employed to define geographic and/or healthcare practice pattern variables (ex. All Medical Discharges per 1000 enrollees, etc. . . ) that are related to, and used to determine, risk events and financial risk.

In certain embodiments, the application 104 uses a modified Charlson Index, Models for Medicare Risk Adjustment, or like validated data which appear to identify factors that can be used to define a mix of patients based on severity of a condition. Thus, the application 104 may use factors with validated weights (from Charlson) along with panel-defined weights to determine the type of condition and the severity of a condition for each patient of a population. In one embodiment, the application 104 employs formal disease staging to identify predictors associated with particular diseases. For example, Diabetes be classified by Type 1, Type 2, and GDM, with each possibly requiring different effective care measures.

In one embodiment, a threshold score is assigned to each Diabetes type to enable identification of the type of Diabetes and, thereby, determine whether a particular measure is expected. Other predictors and/or factors such as comorbidities and contraindications may be included to determine the expected measures (E). For example, an elderly man with Type 2 diabetes and heart disease or high blood pressure may be expected to have an eye exam (if not performed within a year). Another predictor may be that the patient's data included the diagnosis of Type 2 diabetes. However, in other embodiments, the risk adjustments is not particularly associated with an illness and/or condition. This serves the purpose of removing variation related to the patient's illness from the measurement of provider performance. This reduces the likelihood of rewarding providers for taking care of less ill patients while punishing providers for taking care of sicker patients.

As evidenced by the foregoing discussion and illustrations, the systems and methods relating to measurement of longitudinal efficiency of the invention are useful in a wide range of applications. While this invention has been particularly shown and described with reference to preferred embodiments thereof, it will be understood by those skilled in the art that various changes in form and details may be made therein without departing from the scope of the invention encompassed by the appended claims.

It will be apparent to those of ordinary skill in the art that methods involved in the present invention may be embodied in a computer program product that includes a computer usable and/or readable medium. For example, such a computer usable medium may consist of a read only memory device, such as a CD ROM disk or conventional ROM devices, or a random access memory, such as a hard drive device or a computer diskette, or flash memory device having a computer readable program code stored thereon.

What is claimed is:

1. A system for measuring unwarranted healthcare service variations comprising:
a computer;
a computer readable medium, operatively coupled to the computer, the computer readable medium program codes performing functions comprising:
A. accessing patient data associated with a patient population,
B. applying a predictive model to the patient data to determine the number of times that a healthcare measure is expected to occur,
C. accessing the patient data to determine the number of times that the healthcare measure occurred, and
D. comparing the number of times that the measure occurred with the number of time that the measure was expected to occur to identify the unwarranted healthcare service variation.

2. The system of claim 1 comprising measuring the unwarranted healthcare service variation as a difference in the number of times that the measure occurred with the number of time that the measure was expected to occur.

3. The system of claim 1 comprising measuring the unwarranted healthcare service variation as a ratio of the number of times that the measure occurred to the number of time that the measure was expected to occur.

4. The system of claim 1, wherein the healthcare measure is categorized into one or more categories.

5. The system of claim 4, wherein the categories include at least one of effective care, supply sensitive care, and preference sensitive care.

6. The system of claim 1 comprising performing functions A-D for a plurality of different patient populations.

7. The system of claim 6, comprising comparing the unwarranted healthcare service variations of the plurality of patient populations to identify populations associated with one or more ranges of unwarranted healthcare service variation.

8. The system of claim 6, wherein the patient population is associated with one of a physician, a physician practice, a hospital, a state, and a region.

9. The system of claim 1, wherein the predictive model includes at least one of a rules-based model and a statistical model.

10. The system of claim 9, wherein the rules-based model includes a panel of experts that identify one or more predictors associated with a measure.

11. The system of claim 10 comprising using at least portions of a Delphi technique to identify the one or more predictors.

12. The system of claim 9, wherein the predictive model includes a logistic regression model that identifies one or more predictors that are associated with a measure.

13. A method for measuring unwarranted healthcare service variations comprising:
A. accessing patient data associated with a patient population,
B. applying a predictive model to the patient data to determine the number of times that a healthcare measure is expected to occur,
C. accessing the patient data to determine the number of times that the healthcare measure occurred, and
D. comparing the number of times that the measure occurred with the number of time that the measure was expected to occur to identify the unwarranted healthcare service variation.

14. The method of claim 13 comprising measuring the unwarranted healthcare service variation as a difference in the number of times that the measure occurred with the number of time that the measure was expected to occur.

15. The method of claim 13 comprising measuring the unwarranted healthcare service variation as a ratio of the number of times that the measure occurred to the number of time that the measure was expected to occur.

16. The method of claim 13, wherein the healthcare measure is categorized into one or more categories.

17. The method of claim 16, wherein the categories include at least one of effective care, supply sensitive care, and preference sensitive care.

18. The method of claim 13 comprising performing functions A-D for a plurality of different patient populations.

19. The method of claim 18, comprising comparing the unwarranted healthcare service variations of the plurality of patient populations to identify populations associated with one or more ranges of unwarranted healthcare service variation.

20. The method of claim 18, wherein the patient population is associated with one of a physician, a physician practice, a hospital, a state, and a region.

21. The method of claim 13, wherein the predictive model includes at least one of a rules-based model and a statistical model.

22. The method of claim 21, wherein the rules-based model includes a panel of experts that identify one or more predictors associated with a measure.

23. The method of claim 22 comprising using at least portions of a Delphi technique to agree upon one or more predictors.

24. The method of claim 21, wherein the predictive model includes a logistic regression model that identifies one or more predictors that are associated with a measure.
